(19) United States
(12) Patent Application Publication
(10) Pub. No.: US 2014/0005802 A1
(43) Pub. Date: Jan. 2, 2014

(54) PROCESS CONTROL APPARATUS & METHOD

(71) Applicant: Control Techniques Limited, Newtown (GB)

(72) Inventor: Wang Lei, Shenzhen (CN)

(21) Appl. No.: 13/929,391

(22) Filed: Jun. 27, 2013

(30) Foreign Application Priority Data
Jun. 28, 2012 (CN) 201220314018.5

(51) Int. Cl. G05B 15/02

(52) U.S. Cl. CPC G05B 15/02
USPC 700/4

(57) ABSTRACT

A control device, a control method and system for controlling switching in/out of execution device in a system having plurality of execution devices in parallel, are disclosed. A group of execution devices perform predetermined operations on an execution object. The control device comprises feedback unit configured to provide the difference between reference quantity and feedback quantity; and at least one control unit corresponding to each execution device of the group of execution devices respectively, which is configured to provide a target value to a driver of a corresponding execution device using a control mode based on the difference, and when any of the other execution devices are switched in/out, provide a target value to the driver using another control mode. The driver drives the corresponding execution device based on the target value. The impact to the execution object may be suppressed and/or the adjustment time may be shortened.

### CROSS-REFERENCE TO RELATED APPLICATION

This application claims the benefit and priority of Chinese Utility Model Patent Application No. 201220314018.5 filed Jun. 28, 2012. The entire disclosure of the above application is incorporated herein by reference.

### FIELD OF THE INVENTION

The present disclosure relates to process control, and in particular, to a control device, a control method and a corresponding system for controlling switching in/out of a control device in a system with a plurality of devices operating in parallel.

### BACKGROUND OF THE INVENTION

Generally, in applications which need to control a process having a process variable, such as fluid flow or pressure, there is a need to control the process variable with minimal disturbance to the process. Typical applications include water supply systems, oil supply, chemical processes and other fluid processes such as air heating and cooling systems.

In an existing system which controls a motor through a drive, a single high power motor coupled to the control device, such as a pump, is driven by the drive, whereby the flow or pressure can be controlled. In another system which drives a motor through a drive, multiple low power motors are configured to control the flow or pressure in parallel. Each motor assists in controlling the flow or pressure independently, wherein at least one motor is controlled by a drive during the process control operation.

Using multiple low power motors has several advantages. On the one hand, the cost of using multiple low power motors is lower. On the other hand, when using a single high power motor, the system cannot work once the motor fails due to lack of any backup motor. Thus, using multiple low power motors can improve the reliability of the system.

However, using multiple low power motors involves switching in/out of motors when the operating conditions change. For example, in the case that the motors serve as water pumps to supply water at a constant pressure, if the water flow demand (i.e. the load) increases, other motors can be switched into the system in order to maintain the pressure in the pipe. However, such operations may have a disturbing impact on the process control and thus generate unwanted fluctuations in the intended control characteristics. In addition, a certain period is needed to recover from the disturbance of switching in/out of motors.

### SUMMARY OF THE INVENTION

In view of the above, the present disclosure is intended to provide a control device and a control method for controlling switching in/out of process control devices in a system with a plurality of such devices in parallel. Suppressing the transitional impact on the control characteristics caused by switching in/out of the devices, shortens the recovery time and reduces disturbance.

The accompanying claims recite features of the disclosed embodiments.

According to an embodiment of the disclosure, a control device controls switching in/out of an execution device in a system with a plurality of execution devices in parallel, wherein the plurality of execution devices perform predetermined operations on an execution object of the system, and comprise a first group of execution devices which consists of at least one execution device. The control device comprises: a feedback unit configured to provide a difference between a feedback quantity from the execution object and a reference quantity; and at least one control unit corresponding to each execution device in the first group of execution devices respectively, which is configured to, when other execution devices in the system which are parallel to a corresponding execution device in the first group of execution devices are not switched in/out, provide a target value to a driver of the corresponding execution device using a first control mode based on the difference, and when any of the other execution devices are switched in/out, provide a target value to the driver using a second control mode which is different from the first control mode. Herein the driver drives the corresponding execution device based on the target value.

According to an embodiment of the disclosure, it is also provided a control method for controlling switching in/out of execution device in a system with a plurality of execution devices in parallel, wherein the plurality of execution devices perform predetermined operations on an execution object of the system, and comprise a first group of execution devices which consists of at least one execution device. The control method comprises: when other execution devices in the system which are parallel to a corresponding execution device in the first group of execution devices are not switched in/out, providing a target value to a driver of the corresponding execution device using a first control mode based on a difference between a feedback quantity from the execution object and a reference quantity; when any of the other execution devices are switched in/out, providing a target value to the driver using a second control mode which is different from the first control mode; and driving the corresponding execution device based on the target value.

According to an embodiment of the disclosure, it is also provided a system having a plurality of execution device in parallel, wherein the plurality of execution devices perform predetermined operations on an execution object of the system, and comprise a first group of execution devices which consists of at least one execution devices. The system comprises: the control device as described above configured to provide a target value; and at least one control unit for driving each execution device in the first group of execution devices respectively, which is configured to receive the target value provided by the control device.

In the control device, control method and corresponding system provided according to the embodiments of the disclosure, at least one of following objects is achieved: suppressing the impact to execution object caused by switching in/out of the execution devices, shortening the adjustment time and the like.

### BRIEF DESCRIPTION OF THE DRAWINGS

The above and other objects, features and advantages of the disclosure will be apparent to those skilled in the art in combination with the embodiments of the disclosure and the drawings, in which:

FIG. 1 is a schematic view that shows a system to which the device according to an embodiment of the disclosure is applied;

FIG. 2A is a schematic view that shows the change of the controlled variable in the system in FIG. 1 when motors are switched in and out, when the motor configured with the transducer in FIG. 1 is controlled according to the prior art;

FIG. 2B is a schematic view that shows the change of the controlled variable in the system in FIG. 1 when motors are switched in and out, when the motor configured with the transducer in FIG. 1 is controlled according to an embodiment of the disclosure;

FIGS. 3A and 3B are schematic views that show the change with respect to the target frequency and actual frequency of the motor configured with the transducer when another motor is switched in, according to the prior art and according to an embodiment of the disclosure, respectively;

FIG. 4 is a schematic flow chart that shows the method according to an embodiment of the disclosure; and

FIG. 5 is a schematic flow chart that shows the method according to another embodiment of the disclosure.

### DETAILED DESCRIPTION OF THE EMBODIMENTS

In order to achieve such objects as suppressing the disturbance on the load caused by switching in/out of the execution devices, for example electric motors, and/or shortening the recovery time and the like, the embodiments of the disclosure provide a control apparatus and a control method for controlling switching in/out of devices in a system with a plurality of devices in parallel, wherein the plurality of execution devices perform predetermined operations within the control function.

The control apparatus provided according to an embodiment of the disclosure comprises: a feedback unit configured to provide a feedback signal indicative of the difference between a feedback quantity of the load and a reference quantity; and at least one control unit corresponding to each device in the first group of devices respectively When other devices in the system are in parallel with a corresponding device in the first group of execution devices not controlled to be switched in/out, the control unit provides a target value to a driver of the corresponding device using a first control mode based on the feedback signal, and when any of the other devices are switched in/out, provide a load target value to the driver using a second control mode which is different from the first control mode. Herein the driver drives the corresponding device based on the target demand value.

The control method provided according to an embodiment of the disclosure comprises: when other execution devices in the system which are parallel to a corresponding execution device in the first group of execution devices are not switched in/out, providing a target value to a driver of the corresponding execution device using a first control mode based on a difference between a feedback quantity from the execution object and a reference quantity; when any of the other execution devices are switched in/out, providing a target value to the driver using a second control mode which is different from the first control mode; and driving the corresponding execution device based on the target value.

In the system having a plurality of execution devices in parallel provided according to an embodiment of the disclosure, the plurality of execution devices perform predetermined operations on a controlled fluid of the system, and comprise a first group of execution devices which consists of at least one execution device. The system comprises: the control device as described above configured to provide a target value; and at least one control unit for driving each execution device in the first group of execution devices respectively, which is configured to receive the target value provided by the control device.

Hereinafter, the implementations of the disclosure will be described in detail in combination with the drawings in order to make the above-described objects, features, and advantages of the disclosure clearer.

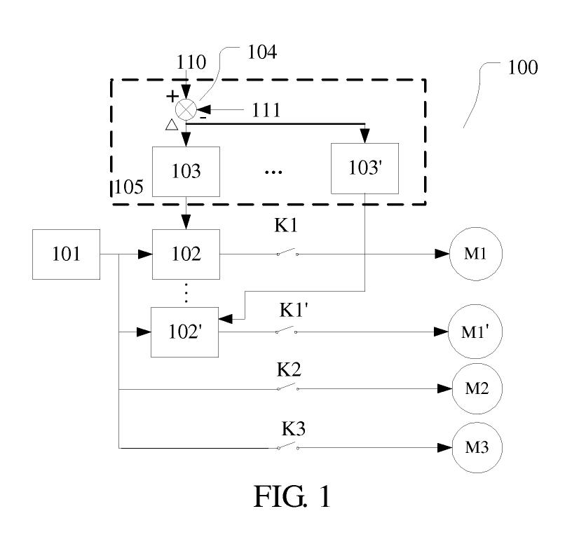

Firstly, a system to which the device according to an embodiment of the disclosure may be applied is described in combination with FIG. 1.

The system 100 in FIG. 1 includes a source of electrical power 101, a drive unit 102 as an example of a driver, a control unit 103, a feedback unit 104, motors M1, M2, and M3 driving control devices (e.g. pumps) connected in parallel as examples of actuating devices, and switches K1, K2, and K3 for switching the motors in and out of operation.

In the system 100, the power source 101 drives the motor M1 through the drive 102, and drives motors M2 and M3 directly. The switches K1, K2, and K3 are used to switch the motors M1, M2, and M3 in/out the system 100 respectively. In this example the drive 102 is a variable voltage, variable frequency inverter used to control A.C. motor speed and torque. Other types of motor and control can be used.

The feedback unit 104 receives a predetermined reference signal 110 corresponding to the control variable set point, which the system 100 is designed to achieve, and a feedback signal 111 from the process variable controlled (in this case fluid pressure) and provides a difference signal Δ therebetween to the control unit 103. Based on the received difference signal Δ, the control unit 103 provides a target frequency to the drive 102. The drive 102 drives the motor M1 with the power from the power source 101 according to the received target frequency, so that the motor M1 drives its control device.

It should be noted that the control unit 103 and the feedback unit 104 form a device for controlling switching in/out of the motor M1 in the system 100 together, which is referred to as a control device 105 in following.

Furthermore, the system 100 may include additional motors M1′ and devices connected in parallel, wherein the motor M1′ and motor M1 form a first group of motors. However, the number of motors included in the first group of motors is not limited to this, and the first group of motors may include only one motor, or include more motors and their corresponding devices.

The system 100 may also include drivers 102′ each corresponding to a motor M1′, corresponding switch K1′, and corresponding control unit 103′. The control unit 103′ may receive the difference signal Δ, and based on the received difference signal Δ, provide the target frequency to the corresponding driver 102′, so that the corresponding driver 102′ can drive the corresponding motor M1′ at the appropriate speed.

It should be understood by those skilled in the art that the structure of the system 100 is not limited to the example shown in FIG. 1. For example, the motors M2 and M3 may also be driven through respective drives, instead of only the motor M1 being driven by the drive. The motors M1, M2, and M3 may be powered by respective power sources, so long as the motors M1, M2, and M3 are connected in parallel, that is, the motors M1, M2, and M3 may perform operations on the controlled variable independently of each other. The numbers of motors and switches may not be limited to the number as shown in FIG. 1, and it is not necessary to keep one-to-one correspondence between the motors and the switches. For example, a plurality of motors may be controlled to be turned on/off by one switch, or one motor may be controlled to turn on/off by a plurality of switches.

In addition, it should be understood by those skilled in the art that the motor is only an example of an actuator. It may also be an internal combustion engine, a steam engine or any other means of driving a device controlling the process variable. Furthermore, this is only an example of the drive 102. The drive may be a drive of any type which is applicable to drive the actuators or the like. The power source may be an energy source of any type which is applicable to supply energy to the execution device. Correspondingly, the control unit may provide a target value of another applicable type to the devices in addition to the target frequency, and the execution devices may output an output value of another applicable type in addition to the actual frequency.

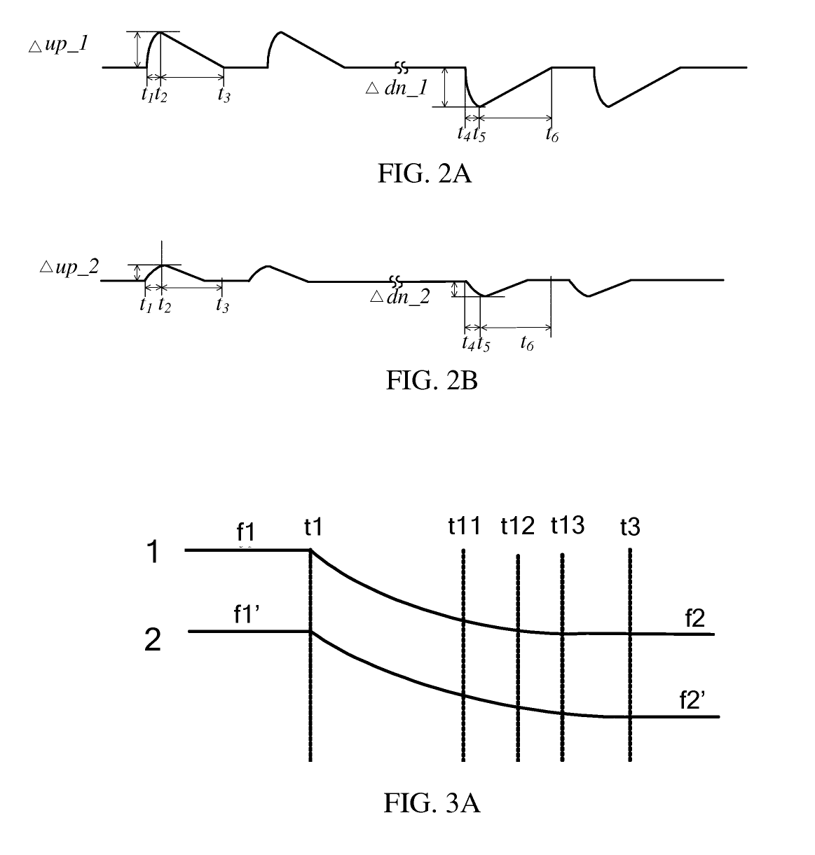

If the control device 105 controls the motor M1 according to the prior art, the change of the controlled variable when the motors M2 and M3 is switched in/out is shown in FIG. 2.

As an example, the controlled variable herein is water pressure in a pipe, and the motors M1, M2, and M3 are connected to drive water pumps. It should be understood by those skilled in the art that the controlled variable herein may also be air flow in a pipe when the motors M1, M2, and M3 are used to drive fans. The controlled variable and the motors may also be of other applicable types. In addition, it should be noted that the machines used for water pumps and fans which may be motors, may also be execution devices of other applicable types such as internal combustion engines and steam engines.

As shown in FIG. 2A, at Time t1, since water volume demand is increased, to keep the water pressure in the pipe to be constant at a target value, the motor M2 switches into the system to start operation. Since the acceleration of the motor M2 is generally fast and exceeds the adjustment rate of the motor M1 which is under control of the control device 105. The water pressure in the pipe rises by Δup_1 quickly between Times t1 and t2. At Time t2, the acceleration of the motor M2 in the startup phase ends. Between Times t2 and t3, the rotation speed of the motor M1 is adjusted under control of the control device 105, so that the water pressure in the pipe is gradually restored to the execution target value.

When the water volume demand continues to increase, the motor M3 switches into the system to start operation, the procedure of which is similar to that of the motor M2 as above and thus the description thereof will be omitted.

When the water volume demand decreases, at Time t4, the motor M2 switches out of the system to stop operation. Since the decreasing rotation speed of the motor M2 in the halt phase exceeds the adjustment rate of the motor M1 which is under control of the control device 105, the water pressure in the pipe drops by Δdn_1 quickly between Times t4 and t5. At Time t5, the rotation speed of the motor M2 drops to zero. Between Times t5 and t6, the rotation speed of the motor M1 is adjusted under control of the control device 105, so that the water pressure in the pipe is gradually restored toward the set point which the system is expected to maintain.

When the water volume demand continues to decrease, the motor M3 switches out of the system to stop operation, the procedure of which is similar to that of the motor M2 as above and thus the description thereof will be omitted.

It should be understood by those skilled in the art that when the water volume demand increases or decreases, the order of switching in/out of the motors is not limited to that as described above, and it may be adjusted according to the practical environment and the design demand.

It can be seen from the description above and with reference to FIG. 2A that since the motor M2 or M3 switches in or out, fluctuation occurs in the water pressure in the pipe. It is advantageous to suppress such fluctuation and/or shorten the adjustment time due to above-described switching in/out of the motor.

If the control device 105 controls the motor M1 according to an embodiment of the disclosure, the control unit 103 provides a target frequency to the drive 102 by using a first control mode based on the received difference signal Δ, when the motors M2 or M3 are not switched in/out, and provides a target frequency to the drive 102 by using a second control mode which is different from the first control mode when the motors M2 or M3 are switched in/out.

In FIG. 2B, the change of the water pressure in the pipe when the motor M1 is adjusted according an embodiment of the disclosure is shown in contrast to FIG. 2A. FIG. 2B will be described in detail below in combination with specific embodiments.

It should be understood by those skilled in the art that the first control mode may be any applicable control mode such as proportional (P) control, proportional integral (PI) control, and proportional integral derivative (PID) control.

The following provides several specific implementations of the second control mode as follows.

### First Embodiment

In the first embodiment of the disclosure, the second control mode includes using control parameters which are different from those of the first control mode, so that the response speed of the second control mode is faster than that of the first control mode, until a first predetermined condition is satisfied.

The first predetermined condition herein may be the feedback signal value reaching a stable state. For example, the change in the feedback value during a certain period is smaller than a certain threshold. However, it should be understood by those skilled in the art that the predetermined condition is not limited to this. For example, it may be expiration of a predetermined period, or any other applicable condition.

In the case that the first control mode is proportional control, for example, the second control mode may use a larger proportional factor (gain), for example, so that the second control mode has a faster response speed.

In the case that the first control mode is proportional/integral control or proportional/integral/derivative control, for example, the second control mode may use a larger gain and/or a smaller integration time factor or combination thereof, for example, so that the second control mode has a faster response speed.

It should be noted that in proportional control, there is a difference Δ between the feedback value and the set point, which does not necessarily equal zero even when the execution object eventually reaches a stable state. However, the proportional/integration control and the proportional/integral/derivative control are non-error control, and the difference Δ between the feedback value and the set point substantially equals zero when the controlled variable eventually reaches a stable state.

It should be understood by those skilled in the art that the first and second control modes are not limited to these, and the other applicable modes may also be used, and correspondingly, the parameters of the second control mode may also be set in other ways, so that the second control mode has a faster response speed than that of the first control mode.

Since the second control mode with a faster response speed is used during switching in/out of the motor M2 or M3, the adjustment time with respect to switching in/out of the motor M2 or M3 can be shorter.

### Second Embodiment

In the second embodiment of the disclosure, the second control mode includes providing a target frequency to the drive 102 based on a first predetermined value which is smaller than the difference Δ received from the feedback unit 104 after switching in of the motor M2 or M3 starts, until a second predetermined condition is satisfied. Additionally or alternatively, the second control mode also includes providing a target frequency to the drive 102 based on a second predetermined value which is larger than the difference Δ received from the feedback unit 104 after switching out of the motor M2 or M3 starts, until a third predetermined condition is satisfied.

Herein, the first predetermined value may correspond to the lower limit of the range in which a target value for the pressure varies, and/or, the second predetermined value may correspond to the upper limit of the range in which the value varies. It should be understood by those skilled in the art that the selection of the first predetermined value and the second predetermined value is not limited to these, and any other applicable value may be employed.

In addition, the second predetermined condition may be the actual frequency of the motor M1 reaching a value corresponding to the demand frequency corresponding to the first predetermined value, in other words, reaching a value corresponding to the first predetermined value; and/or the third predetermined condition may be the actual frequency of the motor M1 reaching a value corresponding to the target frequency corresponding to the second predetermined value, in other words, reaching a value corresponding to the second predetermined value. It should be understood by those skilled in the art that the second and third predetermined conditions are not limited to these, and may be the expiration of a certain period, the feedback value being no longer larger than the set point (for the first predetermined condition) or no longer smaller than the set point (for the second predetermined condition), for example; or may be any other applicable condition.

In the following, the changes of the target motor frequency and the actual motor frequency when the motors M2 and M3 are switched in/out according to the prior art and according to the second embodiment of the disclosure are shown respectively, by way of comparison.

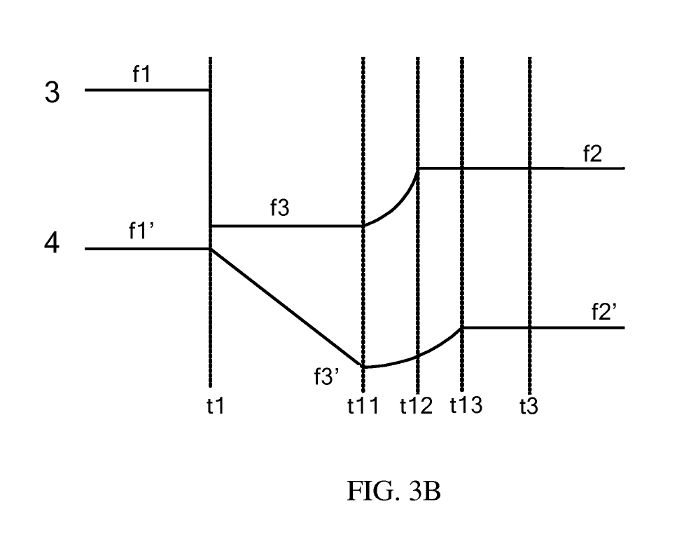

When the motor M1 is controlled by the control device 105 according to the prior art, with reference to FIG. 3A and in combination with the description as above regarding FIG. 2A, it is can be seen that:

1. Before Time t1, the target frequency received by the drive 102 is f1 (the curve 1 in FIG. 3A), and correspondingly, the actual frequency outputted by the motor M1 driven by the drive 102 is f1′ (the curve 2 in FIG. 3A).

2. At Time t1, it is assumed that the volume of water demanded has increased. Therefore, to maintain water pressure the rate of delivery has to increase. This requires that the motor M2 be switched in.

3. In the period between Times t1 and t3, since the operational objective is to keep the water pressure in the pipe to be constant, the set point 110 is constant. However, at this time because of the increased demand and the limited ability of the motor M1 to respond quickly enough, the water pressure in the pipe is higher than the stable value which it is expected to keep, in other words, the feedback value 111 is larger than the set point 110, so that the difference Δ is a negative value. Therefore, the target frequency provided to the drive 102 by the control unit 103 based on the difference decreases from f1 to f2, and correspondingly, the actual frequency outputted by the motor M1 driven by the transducer 102 decreases from f1′ to f2′. It should be noted that since the feedback value increases in the period between Times t1 and t2 shown in FIG. 2A (not shown in FIG. 3A), and decreases in the period between Times t2 and t3 shown in FIG. 2A (not shown in FIG. 3A), the difference decreases in the period between Times t1 and t2 (its absolute values increases), and increases in the period between Times t2 and t3 (its absolute values decreases), until it becomes to zero. Correspondingly, the decreasing rates of the target frequency and the actual frequency increase in the period between Times t1 and t2, and decrease in the period between Times t2 and t3. Additionally, it should be noted that although FIG. 3A schematically shows that the target frequency and the actual frequency both reach a stable state at Time t3, in fact the actual frequency reaches the stable state a little later than the target frequency due to the inherent time delay of the drive 102 and the motor M1.

4. After Time t3, the target frequency received by the transducer 102 keeps f2, and correspondingly, the actual frequency outputted by the motor M1 driven by the drive 102 keeps to f2′. At this time, the water pressure in the pipe reaches a stable state under the collective effect of the motors M1 and M2, and the feedback value 111 substantially equals to the reference value 110, and thus the difference substantially equals to zero if the system enables the set point to be reached for the demanded pressure.

In contrast, when the motor M1 is controlled by the control device 105 according to the second embodiment of the disclosure, with reference to FIG. 3B, it can be seen that:

1. Before Time t1, similar to the control according to the prior art, the target demand frequency received by the drive 102 is f1 (the curve 3 in FIG. 3B), and correspondingly, the actual frequency outputted by the motor M1 driven by the drive 102 is f1′ (the curve 4 in FIG. 3B).

2. At Time t1, the motor M2 is switched into the system to start operation. At this time, the control unit 103 provides a demand frequency f3 to the drive 102 based on a first predetermined value instead of the difference. The first predetermined value corresponds to the lower limit of the range in which a demand value varies under normal operation.

3. In the period between Times t1 and t11, compared with the control according to the prior art, since the demand frequency received by the drive 102 is smaller, the actual frequency outputted by the motor M1 decreases at a faster speed, until at Time t11 a second predetermined condition is satisfied. Herein, the second predetermined condition is the motor M1 reaching an actual frequency f3′ corresponding to the target frequency f3.

4. In the period between Times t11 and t12, the control unit 103 provides the demand frequency to the drive 102 based on the difference instead of the first predetermined value. In other words, the control unit 103 starts to restore the demand frequency to the drive 102 according to the first control mode. Since at this time the demand frequency f3 is lower than the demand frequency f2 when the water pressure in the pipe reaches a stable state, the actual frequency f3′ corresponding to the demand frequency f3 is also lower than the actual frequency f2′ when the water pressure in the pipe reaches a stable state, and the water pressure in the pipe is also lower than the stable value. Therefore, the feedback value 111 is lower than the reference value 110 at this time, and the difference therebetween is a positive value. The target frequency received from the control unit 130 by the drive 102 based on the difference increases, and the actual frequency output by the motor M1 driven by the drive 102 also increases.

5. At Time t12, the demand frequency received by the drive 102 changes to frequency f2. The actual frequency outputted by the motor M1 also reaches f2′ at a later Time t13 due to the inherent delay in response of the drive 102 and the motor M1.

In the control solution according to the second embodiment of the disclosure, the demand frequency received by the drive 102 in the period between Times t1 and t11 is provided by the control unit 103 based on the first predetermined value which is smaller than the difference between the set point 110 and the feedback value 111, therefore the actual frequency outputted by the motor M1 can decrease at a faster speed, so that the adjustment time taken by the motor M1 with respect to switching in of the motor M2 can be shorter.

In addition, through comparison of FIG. 2B and FIG. 2A, it can also be seen that the disturbance on the water pressure in the pipe caused by switching in of the motor M2 can be suppressed through the control.

Specifically, in FIG. 2B, at Time t1, the motor M2 is switched into the system to start operation. In the period between Times t1 and t2, the water pressure in the pipe increases by Δup_2 quickly. Since when using the control according to the second embodiment of the disclosure, the rotation speed of the motor M1 decreases faster than that when using the control according to the prior art, therefore the increase of the water pressure in the pipe due to switching into the system of the motor M2 may be suppressed better, so that Δup_2 is substantially smaller than Δup_1. At Time t2, the acceleration of the motor M2 during the startup phase ends. After Time t2, the motor M1 adjusts the rotation speed under control of the control device 105, so that the water pressure in the pipe is gradually restored to the execution target value before Time t3. In other words, since the water pressure increase in the pipe can be suppressed better when using the control according to the second embodiment of the disclosure, compared to using the control according to the prior art, the adjustment time of the motor M1 is shorter.

In addition, in FIG. 2B, the procedure of the motor M3 being switched in the system to start operation is similar to that described above with respect to the motor M2, and thus the description thereof will be omitted.

In FIG. 2B, at Time t4, the motor M2 is switched out of the system. In the period between Times t4 and t5, the water pressure in the pipe decreases by Δdn_2 quickly. Since when using the control according to the second embodiment of the disclosure, the rotation speed of the motor M1 increases faster than when using the control according to the prior art, therefore the decrease of the water pressure in the pipe due to switching out of the system of the motor M2 may be suppressed better, so that Δdn_2 is substantially smaller than Δup_1. At Time t5, the rotation speed of the motor M2 drops to zero. After Time t5, the motor M1 adjusts the rotation speed under control of the control device 105, so that the water pressure in the pipe is gradually restored to the execution target value before Time t6. In other words, since the water pressure decrease in the pipe can be suppressed better when using the control according to the second embodiment of the disclosure, compared with using the control according to the prior art, the adjustment time of the motor M1 is shorter.

In addition, in FIG. 2B, the procedure of the motor M3 being switched out of the system to start operation is similar to that described above with respect to the motor M2, and thus the description thereof will be omitted.

### Third Embodiment

In the third embodiment of the disclosure, the second control mode includes: the control unit 103 providing a demand frequency to the drive 102 based on a first predetermined value which is smaller than the difference received from the feedback unit 104 after switching in of the motor M2 or M3 starts, until a second predetermined condition is satisfied, and then providing a demand frequency to the drive 102 based on the above difference by using parameters which make the response speed faster than that of the first control mode, until a first predetermined condition is satisfied.

Additionally or alternatively, the second control mode further includes: the control unit 103 providing a demand frequency to the drive 102 based on a second predetermined value which is larger than the difference received from the feedback unit 104 after switching out of the motor M2 or M3 starts, until a third predetermined condition is satisfied, and then providing a demand frequency to the drive 102 based on the above difference by using parameters which make the response speed faster than that of the first control mode, until a first predetermined condition is satisfied.

As described above, it should be understood by those skilled in the art that the first and second predetermined values and the first, second, and third predetermined conditions may be any switchable predetermined value or predetermined condition, and are not limited to those examples listed in the embodiments of the disclosure.

In addition, it should be noted that the first predetermined condition used when making adjustments with respect to switching in of the motor M2 or M3 may be the same condition as the first predetermined condition used when making adjustments with respect to switching out of the motor M2 or M3, or may be different from the first predetermined condition used when making adjustments with respect to switching out of the motor M2 or M3.

Similar to those examples as shown in FIGS. 2B and 3B, in the control according to the third embodiment of the disclosure, in the period between Times t1 and t11, the control unit 103 provides a demand frequency f3 to the drive 102 based on the first predetermined value instead of the difference.

The difference of the third embodiment of the disclosure from the second embodiment of the disclosure is that according to the second embodiment of the disclosure, after Time t11 shown in FIG. 3B, the control unit 103 is restored to provide the demand frequency to the drive 102 according to the first control mode, while according to the third embodiment of the disclosure, the control unit 103 provides the demand frequency to the drive 102 by using parameters which make the response speed faster than that of the first control mode, until a first predetermined condition is satisfied.

Since the control parameters used after Time t11 have faster response speed, compared to the system 100 which is controlled according to the second embodiment of the disclosure, the system 100 which is controlled according to the third embodiment of the disclosure can further shorten the adjustment time taken by the motor M1 with respect to switching in of the motor M2, and suppress the disturbance of the water pressure in the pipe caused by switching in of the motor M2.

In addition, as described above, it should be understood by those skilled in the art that the procedure when the motor M3 is switched in is similar to the procedure described above with respect to the motor M2, and the procedure when the motor M2 or M3 is switched out is also similar to the procedure described above with respect to the motor M2, and thus the description thereof will be omitted.

### Fourth Embodiment

In the fourth embodiment of the disclosure, a method for controlling switching in/out of a control device in a system with a plurality of such devices in parallel will be described. Herein, the plurality of devices perform predetermined operations on a controlled variable of the system (e.g. water pressure), and comprise a first group of devices which consists of at least one such device.

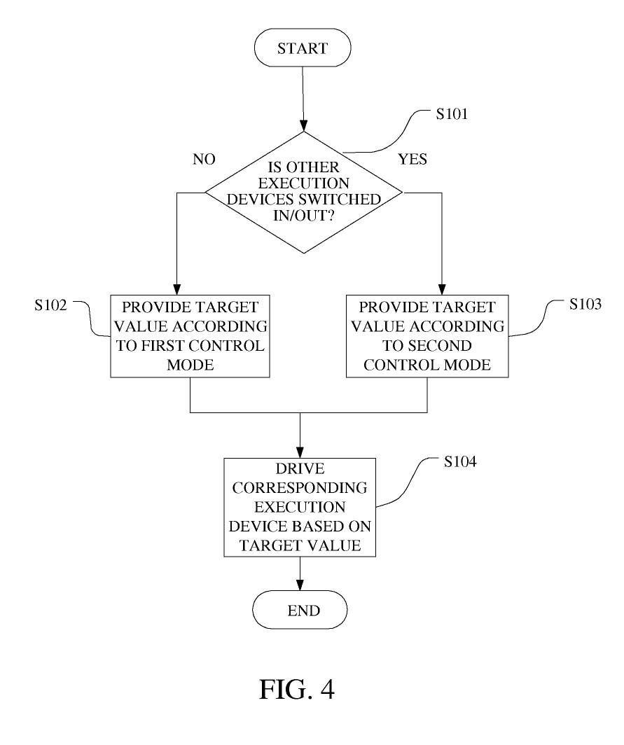

The method will be described in combination with the flow chart shown in FIG. 4 as follows.

In the fourth embodiment of the disclosure, when other devices in the system which are parallel with a corresponding device in the first group of devices are not being switched in/out (“NO” in Step S101), a demand value is provided to a drive of the corresponding device using a first control mode based on a difference between a feedback quantity indicative of the variable and a reference quantity (Step S102); when any of the other devices is switched in/out (“YES” in Step S101), a demand value is provided to the driver using a second control mode which is different from the first control mode (Step S103); and the corresponding device is driven based on the demand value (Step S104).

Herein, for example, the system may be the system 100 shown in FIG. 1, the devices may be the motors M1, M2 and M3 shown in FIG. 1, the first group of devices may contain motor M1, the reference quantity may be the set point 110 shown in FIG. 1, the feedback quantity may be the feedback value 111 shown in FIG. 1, the difference may be the difference signal Δ shown in FIG. 1, the demand value may be the demand frequency described in the first to the third embodiments of the disclosure, the first control mode may be the P control, PI control or PID control mode mentioned above, and the second control mode may be the examples disclosed in relation to the first to the third embodiments of the disclosure.

Based on the disclosure of the first to the third embodiments above, it should be understood by those skilled in the art that at least one of following objects can be achieved by the method according to the fourth embodiment of the disclosure: suppressing the impact on the variable caused by switching in/out of the devices, shortening the adjustment time and the like.

### Fifth Embodiment

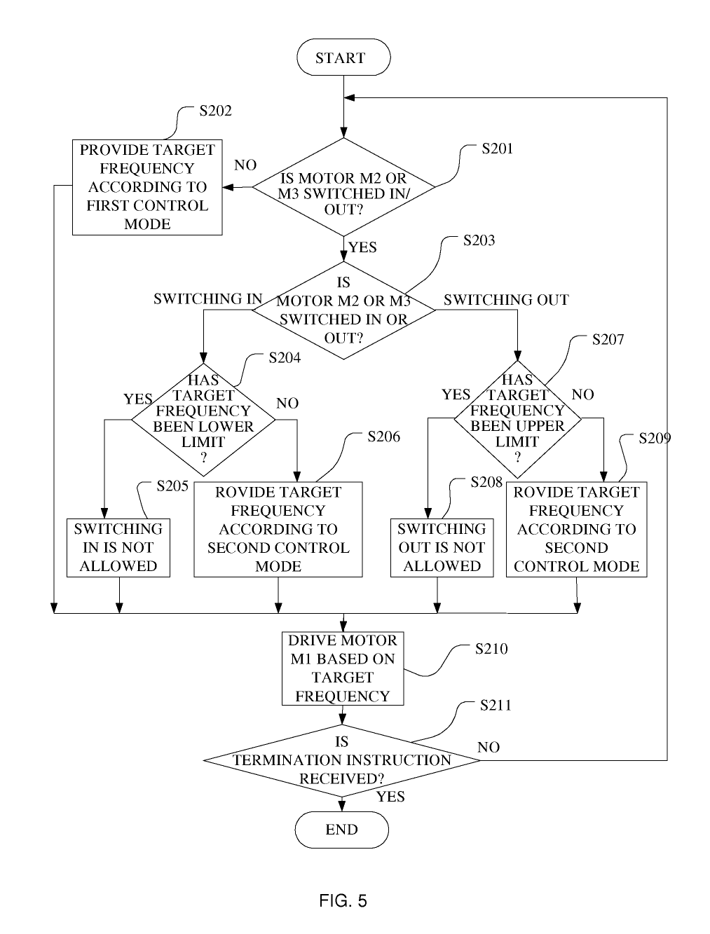

In the fifth embodiment of the disclosure, a method for controlling the switching in/out of the motor M2 or M3 in the system 100 will be described. The method will be described in conjunction with the flow chart shown in FIG. 5 as follows.

In Step S201, whether or not the motor M2 or M3 is being switched in/out is determined. If the motor M2 or M3 is not being switched in/out, the process proceeds to Step S202, or else the process proceeds to Step S203.

In Step S202, the demand frequency is provided to the drive 102 by using the first control mode, and the process proceeds to Step S210.

In Step S203, whether the motor M2 or M3 is being switched in or switched out is determined. If the motor M2 or M3 is being switched in, the process proceeds to Step S204, and if the motor M2 or M3 is being switched out, the process proceeds to Step 207.

In Step S204, the system checks whether or not the demand frequency provided to the drive 102 is already at the lower limit of the range in which the demand frequency varies.

If the demand frequency provided to the drive 102 is already at the lower limit of the range in which the target frequency varies, the process proceeds to Step S205, in which the motor M2 or M3 is not allowed to be switched in. The reason is that, if the demand frequency provided to the drive 102 is already at the lower limit of the range in which the demand frequency varies when the motor M2 or M3 is being switched in, the control device 105 cannot adjust the actual frequency outputted by the motor M1 by reducing the demand frequency provided to the drive 102, and thus cannot suppress the impact caused by the switching in of motor M2 or M3. Optionally, in this case, the pressure in the pipe may be maintained by increasing the demand frequency provided to the drive 102, instead of the switching in of motor M2 or M3. The process proceeds from Step S205 to Step S210.

If the demand frequency provided to the drive 102 is not the lower limit of the range in which the demand frequency varies, the process proceeds to Step S206, in which the demand frequency is provided to the drive 102 by using the second control mode. As to the specific examples of the second control mode, it can be seen in the description of the first to the third embodiments of the disclosure. The process proceeds from Step S206 to Step S210.

Step S207 determines whether or not the demand frequency provided to the drive 102 is already at the upper limit of the range in which the demand frequency varies.

If the demand frequency provided to the drive 102 is already at the upper limit of the range in which the demand frequency varies, the process proceeds to Step S208, in which the motor M2 or M3 is not allowed to be switched out. The reason is that, if the demand frequency provided to the drive 102 is already at the upper limit of the range in which the demand frequency varies when the motor M2 or M3 is being switched out, the control device 105 cannot adjust the actual frequency outputted by the motor M1 by increasing the demand frequency provided to the drive 102, and thus cannot suppress the impact caused by the switching out of motor M2 or M3. Optionally, in this case, the pressure in the pipe may be maintained by reducing the demand frequency provided to the drive 102, instead of the switching out of motor M2 or M3. The process proceeds from Step S208 to Step S210.

If the demand frequency provided to the drive 102 is not at the upper limit of the range in which the demand frequency varies, the process proceeds to Step S209, in which the demand frequency is provided to the drive 102 by using the second control mode. As to the specific examples of the second control mode, it can be seen in the description of the first to the third embodiments of the disclosure. The process proceeds from Step S209 to Step S210.

In Step S210, the drive 102 drives the motor M1 based on the demand frequency, and the process proceeds to the Step S211.

In Step S211, whether or not an instruction for terminating the control process has been received is determined. If the instruction for terminating the process has not been received, the process proceeds to Step S201 and the control process is continued. If the instruction for terminating the process is received, the process is terminated.

It should be noted that, Steps S204 and S205, as well as Steps S207 and S208 optional. In another words, Steps S204 and S205, as well as Steps S207 and S208, may be omitted. In this case, when it is determined in Step S203 that the motor M2 or M3 is being switched in, the process directly proceeds to Step S206, in which the demand frequency is provided to the drive 102 by using the second control mode. Alternatively or additionally, when it is determined in Step S203 that the motor M2 or M3 is being switched out, the process directly proceeds to Step S209, in which the demand frequency is provided to the drive 102 by using the second control mode.

Based on the first to the third embodiments of the disclosure above, it should be understood by those skilled in the art that at least one of following objects can be achieved by the method according to the fifth embodiment of the disclosure: suppressing the impact on the controlled variable caused by switching in/out of the devices, shortening the adjustment time and the like.

### Sixth Embodiment

In the sixth embodiment of the disclosure, a system with a plurality of devices in parallel is provided, wherein the plurality of devices perform predetermined operations on the controlled variable of the system, and comprise a first group of devices which consists of at least one such device. The system comprises: the control device provided according to the first to the third embodiments of the disclosure, which is configured to provide a demand value; and at least one control unit for driving each device in the first group, and which is configured to receive the demand value provided by the control device.

As above, it should be understood by those skilled in the art that the device in this system may be a motor, and may also be an internal combustion engine, a steam engine or the like providing motive power for effecting control of the variable.

Besides, it should be understood by those skilled in the art that this system may use water pumps driven by the drive control, which control the water pressure in pipe system in order to supply water at a constant pressure, as shown in FIG. 1. This system may also use fans, which control air flow for warm air or cold air, in order to maintain air at a constant temperature. This system may further be a system with other applicable types of devices as actuators of fluid control devices.

Due to the applying of the control device according to the first to the third embodiments of the disclosure, at least one of following objects can be achieved by the system according to the sixth embodiment of the disclosure: suppressing the impact to on the controlled variable caused by switching in/out of the devices, shortening the adjustment time and the like.

It should be understood by those skilled in the art that although it is only described above that the control according to the embodiments of the disclosure is performed with respect to the motor M1 configured with the drive 102, if each of a plurality of motors such as motors M1 and M1′ is configured with a drive, that is, if the first group contains a plurality of motors, the control according to the embodiments of the disclosure may be performed with respect to each motor in the first group of motors. For example, each motor may be provided with respective feedback units, and it is also possible to provide a common feedback unit for all the motors as shown in FIG. 1. Besides, each motor may be provided with a respective control unit as shown in FIG. 1. It is also possible to provide a common control unit for all the motors, which provides respective demand frequencies to the drives of respective motors. In other words, the control according to the embodiments of the disclosure may be performed with respect to the corresponding motor in a group which consists of a plurality of motors. In above cases, at least one of following objects can also be achieved: suppressing the impact to on the controlled variable caused by switching in/out of the execution devices, shortening the adjustment time and the like.

It should be understood by those skilled in the art that although the system 100, the controlled variable of which is exemplified by keeping the variable to be substantially constant, is described above, the control according to the embodiments of the disclosure may be applied to other situations. For example, the variable may be changed between predetermined levels, or the variable changed according to predetermined dynamic characteristics. In above cases, by the method or device according to the embodiments of the disclosure, at least one of following objects can be achieved: suppressing the impact on the variable caused by switching in/out of the execution devices, shortening the adjustment time and the like.

It should also be understood by those skilled in the art that although it is described above with respect to a single motor being switched into/out of a system, a plurality of motors may be simultaneously or sequentially switched into/out of a system. In this case, by the method or device according to the embodiments of the disclosure, at least one of following objects can also be achieved: suppressing the impact on the variable caused by switching in/out of the execution devices, shortening the adjustment time and the like.

Although the features, objects and advantages of the technical solution of the disclosure have been described in detail, it should be understood by those skilled in the art that various modifications, alternations and replacements may be performed without departing from the spirit and scope of the present invention defined by the appended claims.

1. A process control apparatus for controlling a process variable, comprising a plurality of process control devices arranged to control the process variable, the apparatus further comprising:
a demand device configured to provide a demand signal for the variable; and
at least one controller operable to control a first group comprising at least one of the devices, the controller being arranged to:
provide a demand signal to the or each device of the first group using a first control mode based on the demand signal, and
provide a demand signal to the or each device of the first group using a second control mode which is different from the first control mode when another device is being switched in or out of operation in a transition, wherein the device or devices in the first group is/are controlled based on the demand signal, the second control mode controlling the devices of the first group during the switching in or out of the other device so that the control of the variable is less disturbed in the transition.

2. The apparatus according to claim 1 in which the demand device comprises a feedback circuit configured to provide the demand signal based on the difference between a reference and a feedback signal based on the variable.

3. The apparatus according to claim 1, wherein the response speed of the second control mode is faster than that of the first control mode and wherein, when any of the other devices are switched in or out:
the controller is configured to provide the demand signal to the device or devices of the first group according to the second control mode until a first predetermined condition is satisfied.

4. The apparatus according to claim 2, wherein when one or more of the other devices is switched in:
the controller is configured to provide the demand signal to the device or devices of the first group according to the second control mode until a second predetermined condition is satisfied.

5. The apparatus according to claim 1, wherein when one or more of the other devices is switched out:
the controller is configured to provide the demand signal to the device or devices of the first group according to the second control mode until a third predetermined condition is satisfied.

6. The apparatus according to claim 2, wherein when one or more of the other devices is switched in:
the controller is configured to provide the demand signal to the device or devices of the first group based on a first predetermined value which is smaller than the difference according to the first control mode, until a second predetermined condition is satisfied, then provide the demand signal to the device or devices of the first group based on the difference by using control parameters which make the response speed faster than that of the first control mode, until a first predetermined condition is satisfied.

7. The apparatus according to claim 1, wherein when one or more of the other devices is switched out:
the controller is configured to provide the demand signal to the device or devices of the first group based on a second predetermined value which is larger than the difference according to the first control mode until a third predetermined condition is satisfied, then provide the demand signal to the device or devices of the first group based on the difference by using control parameters which make the response speed faster than that of the first control mode, until a first predetermined condition is satisfied.

8. The apparatus according to claim 3, wherein:
the first predetermined condition is the feedback signal when the system reaches a steady state.

9. The apparatus according to claim 4, wherein:
the first predetermined value corresponds to the lower limit of the range within which the demand signal varies, or
wherein the second predetermined condition is an output signal of the device reaching a value corresponding to the first predetermined value.

10. The apparatus according to claim 5, wherein:
the second predetermined value corresponds to the upper limit of the range within which the demand signal varies, or
wherein the third predetermined condition is an output signal of the device reaching a value corresponding to the second predetermined value.

11-12. (canceled)

13. The apparatus according to claim 1, wherein:
the first control mode is a proportional, proportional/integral or proportional/integral/derivative control mode.

14. A method for controlling devices in which a plurality of process control devices in parallel control a process variable arranged as a first group comprising at least one device and at least another device not in the first group, the method comprising:
when the other device or devices are not being switched in or out of operation to control the variable, providing a demand signal to the at least one device of the first group using a first control mode,
when any one or more of the other devices are being switched in or out of operation to control the variable, providing a demand signal to the device using a second control mode which is different from the first control mode, and driving the device or devices of the first group based on the demand signal.

15. The method of claim 14, in which the first control mode comprises a feedback signal for providing the demand signal based on the difference between a reference and a feedback signal based on the variable, or
wherein when the demand signal to the device is the lower limit of a range within which the demand signal varies, the other device or devices are prevented from being switched in, or
wherein when the demand signal to the device is the upper limit of a range within which the demand signal varies, the other device or devices are prevented from being switched out.

16-17. (canceled)

18. The method according to claim 14, wherein:
the process of providing the demand signal to the device using the second control mode comprises:
providing the demand signal to the device until a first predetermined condition is satisfied, wherein the response speed of the second control mode is faster than that of the first control mode.

19. The method according to claim 14, wherein:
the process of providing the demand signal to the device using the second control mode comprises:
providing the demand signal to the device based on the first predetermined value which is smaller than the difference after any of the other execution devices start to be switched in, until a second predetermined condition is satisfied.

20. The method according to claim 14, wherein:
the process of providing the demand value to the device by using the second control mode comprises:
providing the demand signal to the device based on the second predetermined value which is larger than the difference after one or more of the other execution devices start to be switched out, until a third predetermined condition is satisfied.

21. The method according to claim 14, wherein:
the process of providing the demand signal to the device by using the second control mode comprises:
providing the demand signal to the device based on a first predetermined value which is smaller than the difference after any of the other devices start to be switched in, until a second predetermined condition is satisfied, then providing the demand signal to the device based on the difference by using control parameters which make the response speed faster than that of the first control mode, until a first predetermined condition is satisfied, or
wherein the process of providing demand signal to the device by using the second control mode comprises:
providing the demand signal to the device based on a second predetermined value which is larger than the difference after any of the other execution devices start to be switched out, until a third predetermined condition is satisfied, then providing the demand signal to the device based on the difference by using control parameters which make the response speed faster than that of the first control mode, until a first predetermined condition is satisfied.

22. (canceled)

23. The control method according to claim 18, wherein:
the first predetermined condition is the feedback quantity reaching a steady state.

24. The control method according to claim 19, wherein:
the first predetermined value corresponds to the lower limit of a range within which a demand signal varies.

25. The control method according to claim 20, wherein:
the second predetermined value corresponds to the upper limit of a range within which a demand signal varies, or
wherein the third predetermined condition is the output signal of the device reaching a value corresponding to the first predetermined value.

26. The control device according to claim 19, wherein:
the second predetermined condition is the output signal of the device reaching a value corresponding to the first predetermined value.

27. (canceled)

28. The control method according to claim 15, wherein:
the first control mode is a proportional, proportional/integral or proportional/integral/derivative control mode.

29. A system having a plurality of execution device in parallel, wherein:
the plurality of execution devices perform predetermined operations on an execution object of the system, and comprise a first group of execution devices which consists of at least one execution devices, and
the system comprises:
apparatus according to claim 1 configured to provide a target value; and
at least one control unit for driving each execution device in the first group of execution devices respectively, which is configured to receive the target value provided by the control device.

30. The system according to claim 29, wherein:
the device comprises a motor, or
wherein the device comprises a water pump and the controlled variable is water pressure in a pipe; and
the system is used to supply water at a regulated pressure, or
wherein the device comprises a fan for moving air; and
the system is used to supply air at a regulated temperature.

31-32. (canceled)
